(19) United States
(12) Patent Application Publication
(10) Pub. No.: US 2005/0111097 A1
(43) Pub. Date: May 26, 2005

(54) Head mounted binoculars/range finder

(76) Inventors: Thomas M. Iannarelli, Broomall, PA (US); Timothy L. Gardner, Fleetwood, PA (US)

Correspondence Address: MICHAEL F. PETOCK, ESQUIRE, 46 THE COMMONS AT VALLEY FORGE, 1220 VALLEY FORGE ROAD, P.O. BOX 856, VALLEY FORGE, PA, 19482, US

(21) Appl. No.: 10/722,663

(22) Filed: Nov. 26, 2003

(51) Int. Cl. G02B 23/00

(52) U.S. Cl. 359/409; 359/407

(57) ABSTRACT

An apparatus for head mounting gear for hands free operation includes a headband and adjustable mounting structure wherein gear such as binoculars and range finders may be selectively mounted, and such gear once mounted may be conveniently raised to a storage position or placed in a use position. The structure includes a quick release mechanism which enables quick and easy interchange between various gear. The headband is preferably comprised of an encircling band and a band that goes over the top of the head. The mounting support structure has adjustments for length from the eyes and height. It is further adjustable into multiple use positions and vertical angle line of sight adjustment.

### FIELD OF THE INVENTION

The present invention relates to an apparatus for head mounting gear for hands free operation. More particularly, the present invention relates to an apparatus for preferably selectively mounting binoculars or a range finder on the head of a wearer for hands free operation.

### BACKGROUND OF THE INVENTION

In various types of activities, it would be desirable to be able to provide hands free operation of binoculars. This may apply to hunting, sporting events, bird watching and other activities wherein binoculars need to be used. Further, there is often a problem with holding binoculars steady when held by hand to view items with binocular magnification at a distance.

Even the carrying of binoculars on a string around the wearer's neck may be dangerous during certain activities such as bow and arrow hunting. Instances have been reported where a person having a binocular string around his neck has been severely injured by the release of the string under tension on a bow of a bow and arrow.

At least one attempt has been made in the past to produce a head mounted binocular, such as that disclosed by U.S. Pat. No. 6,369,958 B1—Himmele. Himmele discloses a sports binocular assembly which includes an adjustable head securing strap and a pair of positioning arms mounted on the sides of a head. The binoculars are positioned within a case mounted on the pair of positioning arms.

Himmele also discloses in published pending patent application, US 2002/0145814 A1, a similar visor bill which can hold binocular lenses with an optical lens cover. This is mounted on a similar pair of arms.

### SUMMARY OF THE INVENTION

The present invention provides an apparatus for head mounting gear, preferably either binoculars or a range finder, for hands free operation. One advantage of the present invention is that it provides a secure stable mount for either binoculars or a range finder.

Another advantage of the present invention is that it enables the binoculars or range finder to be held steady independent of the steadiness of the hands and arms of the wearer.

Another advantage of the present invention is that it may be used for various activities including hunting, sporting events, bird watching and the like.

Another advantage of the present invention is that the binoculars or range finder may be adjusted both horizontally and vertically to adapt to the wearer.

Another advantage of the present invention is that the binoculars or range finder may be securely mounted in place for use or mounted in a raised position for storage.

Another advantage of the present invention is that it may provide multiple detent positions for its use positions.

Briefly and basically, in accordance with the present invention, an apparatus for head mounting gear for hands free operation is provided. The apparatus includes a head mounting means comprised of an encircling band and a top band. The encircling band encircles the head of a wearer and the top band goes over the top of the head of the wearer and is connected to the encircling band. A mounting bracket is mounted to the encircling band. The mounting bracket is provided with a pivot means. A support bar having a proximal end and a distal end is provided. The support bar is pivotally mounted at its proximal end to the pivot means of the mounting bracket. The support bar is lockable by a detent mechanism in at least one position for use and a position for storage. A quick release mounting mechanism is mounted on the distal end of the support bar. Gear may be mounted to the quick release mounting mechanism. The gear may be binoculars, range finders or the like. In this manner, gear such as binoculars or range finders may be used without being held by hand.

In accordance with a presently preferred embodiment, the support bar is provided in the form of two sections arranged at substantially a 90 degree angle wherein the length of each section may be adjusted to provide horizontal and vertical adjustment of the binoculars or range finder. In another preferred embodiment of the present invention, the quick release mounting mechanism is pivotally mounted on the distal end of the support bar to provide angle adjustment of the binoculars or range finder. In another aspect of the present invention, the detent mechanism is provided by spring loaded pins which engage openings in the mounting bracket. The spring loaded releasable pins may be readily released by a pin release means. In a presently preferred embodiment of the present invention, the range finder may be provided with a remote control. The remote control may be provided with a clip for clipping the remote control to an article of clothing of the wearer wherein the range finder may be operated as desired without having to raise the person's hand up to the range finder.

In a preferred embodiment of the present invention, the detent mechanism may be lockable in a second position for use wherein the use position may be selected to accommodate the wearer.

In accordance with a preferred embodiment of the present invention, the quick release mounting mechanism is provided with a spring clip which retains a pair of guide rails on the gear, such as the binoculars or range finder, in a channel formed in the quick release mounting mechanism. An item of gear, such as binoculars, may be readily removed by moving or retracting the spring clip and sliding the guide rails of the binoculars out of the quick release mounting mechanism. The range finder may be quickly installed by holding the spring clip retracted and sliding the guide rails of the remote control into the channel of the quick release mounting mechanism.

In a preferred embodiment of the present invention, the back of the channel of the quick release mounting mechanism is provided with a resilient pad for securely retaining a pair of guide rails in position without movement.

In a presently preferred embodiment, the mounting bracket may be provided with a stop to prevent pivotable movement of the support bar beyond a predetermined point to prevent gear, such as binoculars or a range finder, from contacting the face of the wearer.

### BRIEF DESCRIPTION OF THE DRAWINGS

For the purpose of illustrating the invention, there are shown in the drawings forms which are presently preferred; it being understood, however, that this invention is not limited to the precise arrangements and instrumentalities shown.

FIG. 1 is a view in perspective of an apparatus in accordance with the present invention with binoculars installed.

FIG. 2 is a side elevation view of the apparatus of FIG. 1 illustrating in dotted outline the binoculars in a second use position.

FIG. 3 is a side elevation view of an apparatus in accordance with the present invention illustrating binoculars in the storage position.

FIG. 4 is an exploded partially broken away view in perspective of the mounting and adjustment structure of the present invention.

FIG. 5 is a cross sectional view taken along line 5-5 of FIG. 4 illustrating a detent mechanism in the locked position.

FIG. 5A is a cross sectional view taken along line 5-5 of FIG. 4 showing the detent mechanism in the release position.

FIG. 6 is a cross sectional view taken along line 6-6 of FIG. 4 showing the support bar length adjustment means in a locked position.

FIG. 6A is a cross sectional view taken along line 6-6 of FIG. 4 showing the support bar length adjustment means in an unlocked position.

FIG. 7 is a cross sectional view partially broken away taken along line 7-7 of FIG. 4.

FIG. 8 is a cross sectional view taken along line 8-8 of FIG. 4.

### DETAILED DESCRIPTION OF THE PREFERRED EMBODIMENTS

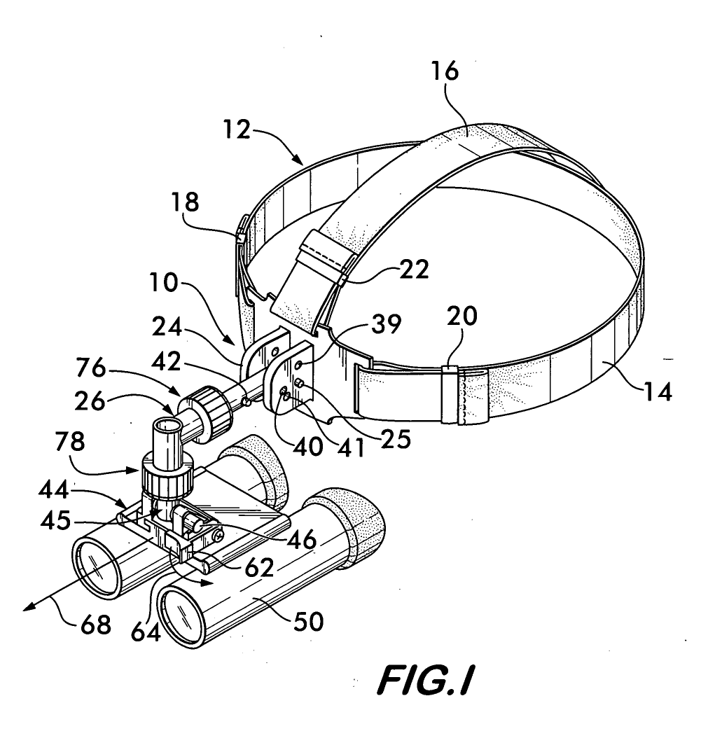

Referring now to the drawings, wherein like numerals indicate like elements, there is shown in FIG. 1 an apparatus 10 for head mounting gear such as binoculars and range finders. Apparatus 10 includes a head mounting means 12 comprised of an encircling band 14 adapted to encircle a head of a wearer and a top band 16 that is adapted to go over the top of the head of the wearer and is connected to the encircling band 14. Both the encircling band 14 and headband 16 are provided with length adjustment means, which may be any suitable means. This may include various types of clips, clamps, hook and loop fasteners such as that commercially available under the trademark “VELCRO” or elastic bands. However, a presently preferred form of strap locking means is illustrated in FIG. 1. For example, encircling band 14 is provided with strap locking means 18 and 20 and the top band is provided with strap locking means 22. Encircling band 14 and top band 16 are preferably constructed of neoprene, but any suitable strap material may be utilized.

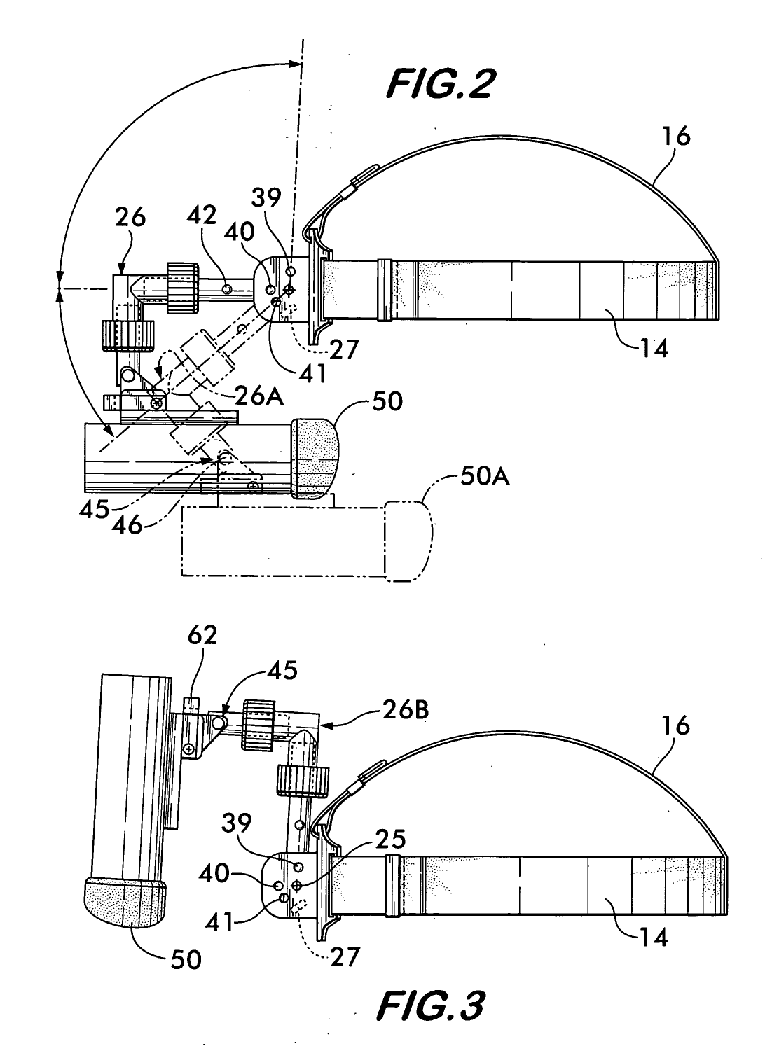

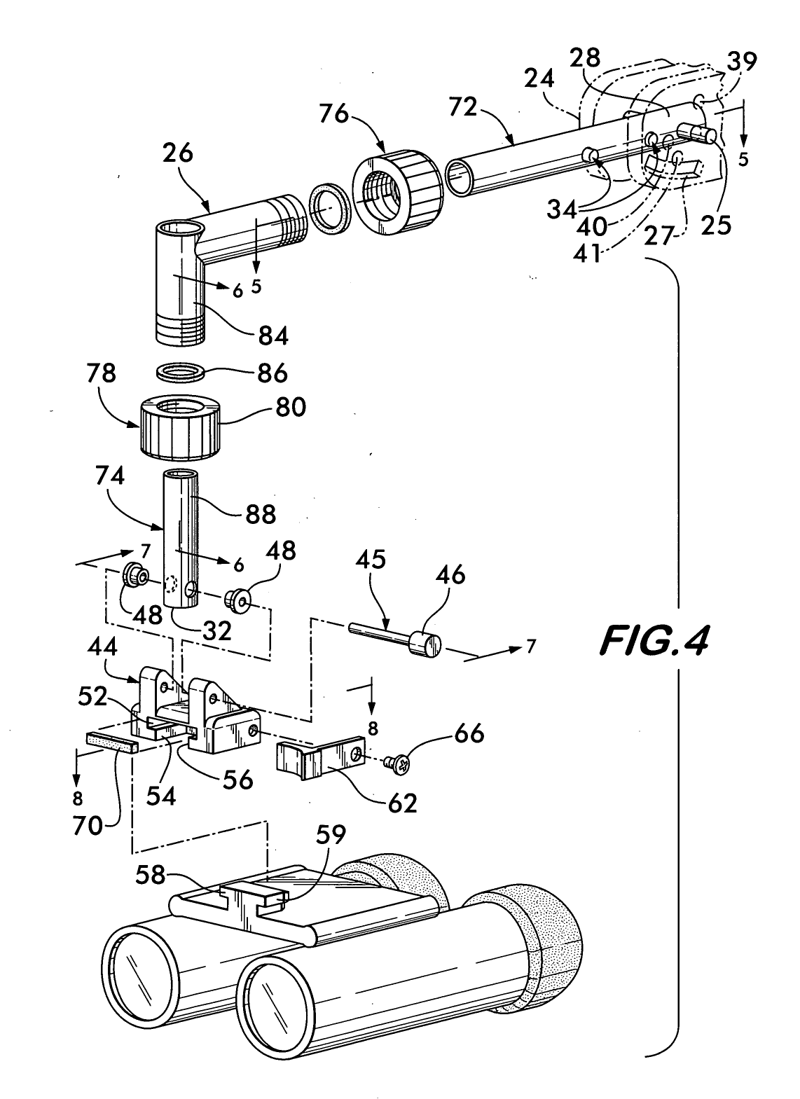

Mounting bracket 24 is mounted to encircling band 14. Mounting bracket 24 is provided with a pivot 25. Pivot 25 is illustrated in greater detail in FIG. 4 and operation about pivot 25 is illustrated in FIGS. 2 and 3.

A support bar 26 has a proximal end 30 and a distal end 32. These may be best viewed in FIG. 4. Support bar 26 is pivotally mounted at its proximal end 28 to pivot 25 of mounting bracket 24. Support bar 26 is pivotable about pivot 25 as best illustrated in FIGS. 2 and 3. Support bar 26 is illustrated in a first use position in solid lines in FIG. 2 and in a second use position in dotted outline in FIG. 2. The second use position in FIG. 2 is labeled 26A. FIG. 3 illustrates support bar 26 pivoted to its storage position and labeled 26B.

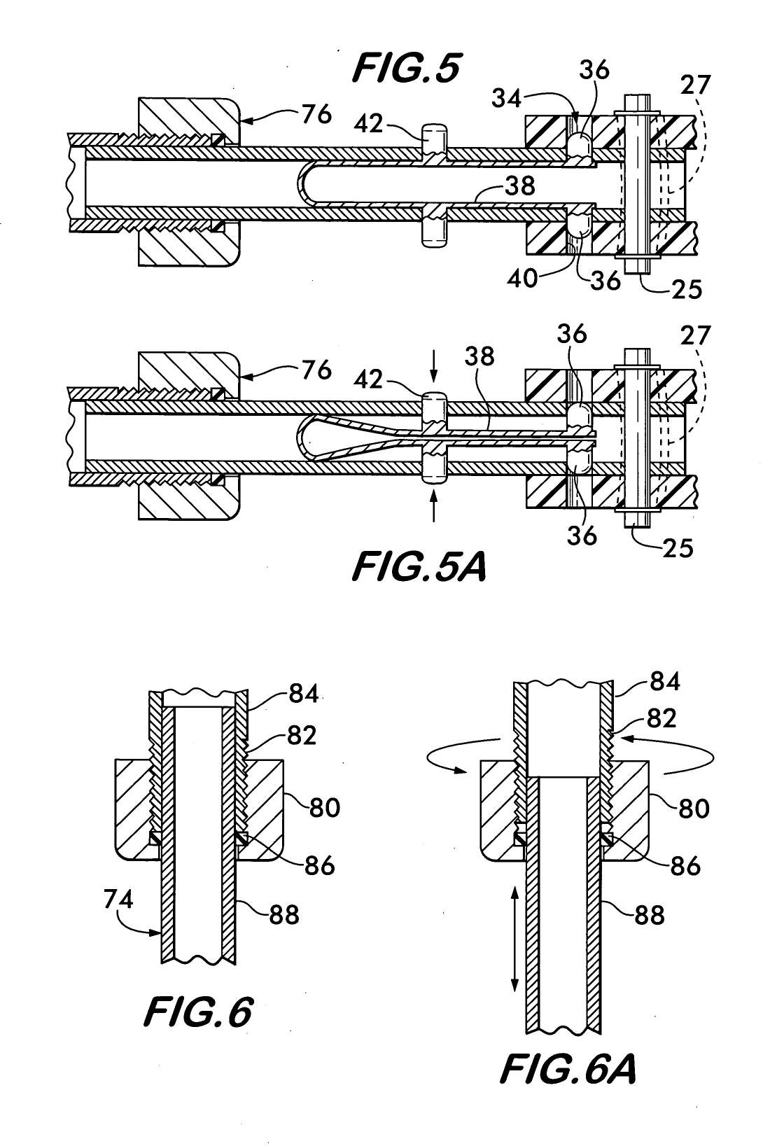

Support bar 26 is lockable by a detent mechanism 34 in the various positions illustrated in FIGS. 1 through 3. Detent mechanism 34 is best illustrated in FIGS. 4, 5 and 5A. It is understood that various other forms of detent mechanism may be utilized. However, in a presently preferred embodiment, pins 36 are provided as best seen in FIGS. 5 and 5A. Pins 36 are mounted on elongated spring element 38 to force pins into openings or holes 39, 40 or 41 in mounting bracket 24. Pins 36 may be released from holes 40 by depressing pin release mechanism or button 42 as illustrated in FIG. 5A. In this manner, buttons 42 may be depressed withdrawing pins 36 from the holes in mounting bracket 24 and allowing adjustment of support bar 26 to another selected position, either one of the two use positions (holes 40 and 41) or the storage position (hole 39). The storage position is illustrated in FIG. 3 and the two use positions are illustrated in FIG. 2. As illustrated in FIG. 4, bracket 24 is provided with a stop 27 which prevents the pivoting of support bar 26 beyond a predetermined point to prevent the gear, such as binoculars 50 or range finder 60, from contacting the face of the wearer accidentally. In other words, stop 27 prevents support bar 26 from moving downwardly significantly beyond the second use position corresponding to hole 41.

A quick release mounting mechanism 44 is mounted on distal end 32 of support bar 26. Gear, such as binoculars 50, may be mounted to quick release mechanism 44 as illustrated in FIG. 1, or range finder 60 may be mounted as illustrated in FIG. 9. Quick release mounting mechanism 44 is preferably adjustably pivotally mounted at 45 to distal end 32 of support bar 26 by means of a tightenable pin 46 and bushings 48, best illustrated in FIG. 4. The usefulness of the adjustable pivot mount 45 is illustrated in FIG. 2 where support arm 26A is adjusted by the detent mechanism such that the pins engage holes 41, pin 46 may be loosened to allow adjustment of binoculars 50 (or range finder 60) to provide proper vertical angle line of sight adjustment or, in other words, to keep the binoculars or range finder substantially parallel to the ground and/or within the user's normal line of sight in the vertical plane. Once the adjustment of the angle is made, pin 46 may be retightened maintaining the new vertical angle adjustment for binoculars 50A in the new position.

Binoculars 50 may be provided with standard adjustments for adjusting the distance between oculars to adjust for differences in the width of eyes of the wearer and may be provided with manual focus adjustments or automatic self adjusting focus means. These standard adjustments are not illustrated in the drawings, but it is understood that such may be provided within the scope of the present invention.

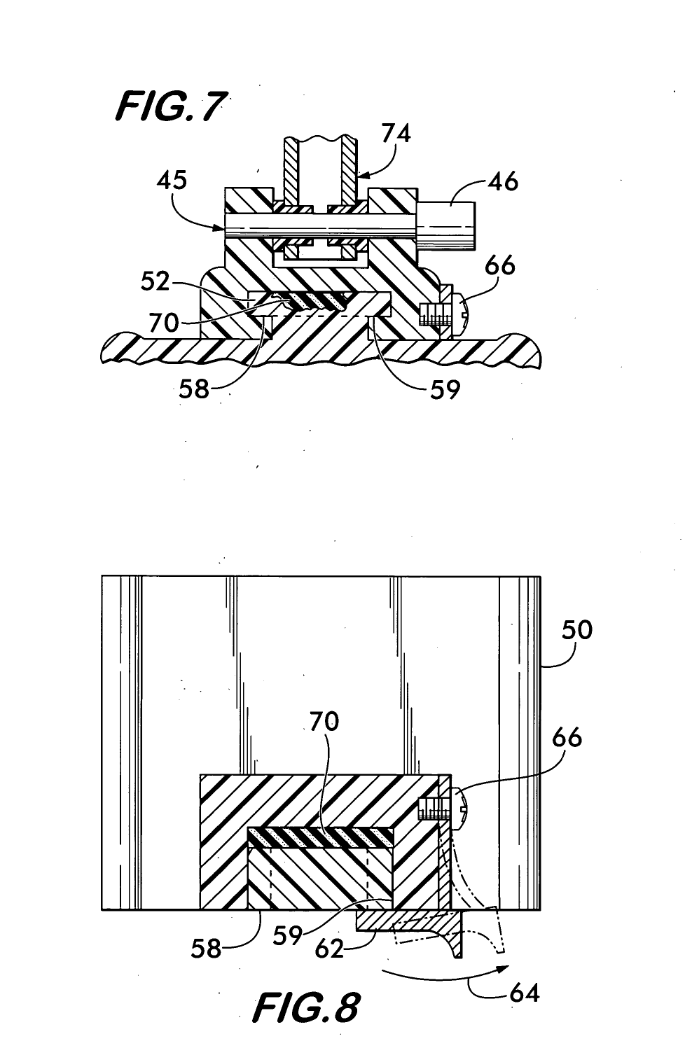

Referring more particularly to FIGS. 4 and 7, quick release mounting mechanism 44 is provided with a channel 52 comprised of side indents 54 and 56 which receive guide rails 58 and 59, respectively of either a binocular or a range finder.

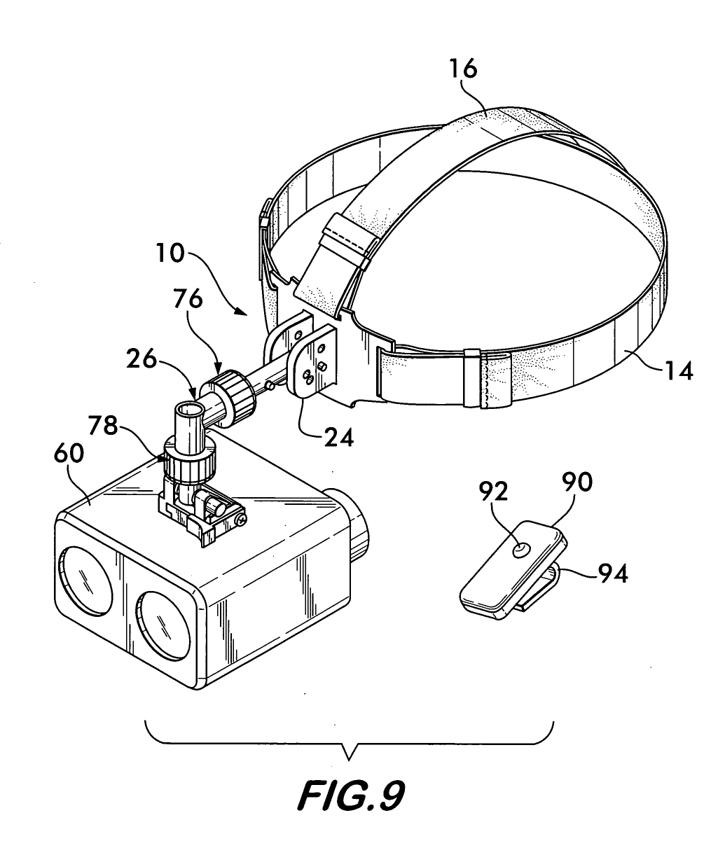

To remove gear from quick release mounting mechanism 44, spring clip 62 is moved or retracted away from quick release mounting mechanism 44 in the direction of arrow 64 as best illustrated in FIGS. 1 and 8. Spring clip 62 is securely mounted to the side of quick release mounting mechanism 44 by a screw 66 or other suitable fastening means. Clip 62 is made of spring or resilient material and may be deflected in the direction of arrow 64 to allow removal of gear, such as binoculars 50 or range finder 62, by allowing sliding in the direction of arrow 68. With spring clip 62 retracted, the guide rails of other gear may be inserted into channel 52 of quick release mounting mechanism 44. In other words, range finder 60 may be installed after binoculars 50 is removed, or vice versa. Further, as best illustrated in FIGS. 4, 7 and 8, the back of channel 52 may be provided with a resilient pad 70 which prevents any slight movement of guide rails 58 and 59 in channel 52 as a result of manufacturing tolerances or the like.

As illustrated in FIGS. 1-4, support bar 26 is provided with a first section 72 and a second section 74 arranged at approximately a 90 degree angle between them. Both first section 72 and second section 74 are adjustable in length. First section 72 is provided with a lockable clutch mechanism 76 and second section is provided with a lockable clutch mechanism 78. Both lockable clutch mechanisms 76 and 78 are of similar structure. The operation of lockable clutch mechanism 78 is best illustrated in FIGS. 4, 6 and 6A. Lockable clutch mechanism 78 is comprised of a threaded nipple 80 which is tighenable on threads 82 of upper tubular member 84. The tightening of nipple 80 causes the compression of friction material 86 which locks tubes 84 and 88 together. As illustrated in FIG. 6A, the loosening of nipple 80 allows friction material 86 to release tubular member 88, allowing adjustment of the length of section 74. Nipple 80 may then be retightened to secure the new adjusted length. The adjustment of section 74 provides vertical adjustment of the gear mounted in quick release mounting mechanism 44. In a similar manner, the length of first section 72 may be adjusted by means of lockable clutch mechanism 76 to adjust the distance of the gear from the user's eyes. Although lockable clutch mechanism 76 and 78 are a presently preferred embodiment providing a convenient and efficient means of continuous adjustability within the range, it is understood that the means for adjusting the length of first section 72 and second section 74 may be any suitable length adjusting means including various other friction engaging means, threadably adjustable means, releasable pins or detent mechanisms, and any other suitable length adjusting means.

A very significant range of adjustability is provided by the present invention. The present invention, in a presently preferred embodiment, provides selection of two different use positions (use of holes 40 or 41 on mounting bracket 24), provides adjustability of the length of first section 72 adjusting the position of the gear in front of the eyes or the distance in front of the eyes, adjustability of the length of second section 74 which adjusts the vertical positioning and adjustability at pivot 45 providing for adjustability of the vertical angle to accommodate the desired line of sight in the vertical plane. Any and all of these parameters may be adjusted to suit the wearer of the apparatus to provide the gear in front of the eyes, such as binoculars, range finder or other optical gear, to suit the desires of the wearer. Further, more or less than two use positions may be provided. All of this is provided in an efficient and effective apparatus which allows quick and easy change of gear on the apparatus.

FIG. 9 illustrates a range finder 60 installed in apparatus 10 of the present invention. Range finder 60 may be operated by a remote control 90. When the wearer desires to determine the range of an object at a distance, the user presses button 92. Remote control 90 then activates range finder 60 by a radio frequency or other suitable transmission. Remote control 90 is provided with a clip 94 which enables the remote control to be attached to an article of clothing of the wearer. In this manner, the wearer's hands are free for other purposes. For example, clip 94 may be attached to a lapel of a shirt of a wearer, a pocket, a belt or any other suitable location on the wearer.

The present invention may be embodied in other specific forms without departing from the spirit or essential attributes thereof and, accordingly, reference should be made to the appended claims, rather than to the foregoing specification as indicating the scope of the invention.

1. An apparatus for head mounting gear for hands free operation, comprising:
a head mounting means comprising an encircling band adapted to encircle a head of a wearer and a top band adapted to go over the top of the head of the wearer and connected to said encircling band;
a mounting bracket mounted to said encircling band, said mounting bracket having a pivot means;
a support bar having a proximal and a distal end, said support bar being pivotally mounted at its proximal end to said pivot means of said mounting bracket;
said support bar being lockable by a detent mechanism in a position for use and a position for storage;
a quick release mounting mechanism mounted on the distal end of said support bar;
gear mounted to said quick release mounting mechanism being selected to be binoculars or a range finder; and
wherein said gear may be used without being held by hand.

2. An apparatus in accordance with claim 1 wherein said encircling band and said top band are made of neoprene.

3. An apparatus in accordance with claim 1 wherein said proximal end of said support bar is provided with a spring loaded releasable pin which mates with an opening in said mounting bracket to form said detent mechanism.

4. An apparatus in accordance with claim 3 wherein said pin in the proximal end of said support bar is released by a pin release means.

5. An apparatus in accordance with claim 1 wherein said quick release mounting mechanism is pivotally mounted on the distal end of said support bar.

6. An apparatus in accordance with claim 1 wherein said quick release mounting mechanism has a channel for receiving a pair of guide rails on a selected gear.

7. An apparatus in accordance with claim 1 wherein said support bar has two sections formed at approximately 90 degrees to each other.

8. An apparatus in accordance with claim 7 wherein said two sections of said support bar are provided with means for adjusting the length of each section.

9. An apparatus in accordance with claim 1 wherein said gear is selected to be a range finder and wherein said range finder is provided with a remote control.

10. An apparatus in accordance with claim 9 wherein said remote control for said range finder is provided with a clip for clipping said remote control to an article of clothing of the wearer.

11. An apparatus in accordance with claim 1 wherein said encircling band is provided with means for adjusting its length.

12. An apparatus in accordance with claim 1 wherein said top band is provided with means for adjusting its length.

13. An apparatus in accordance with claim 1 wherein said support bar is lockable by said detent mechanism in a second position for use, wherein the use position may be selected to accommodate the wearer.

14. An apparatus in accordance with claim 7 wherein said sections are adjustable in length by tubing slidable one within the other and being retained in position by a tightenable clutch.

15. An apparatus in accordance with claim 1 wherein said quick release mounting mechanism is provided with a spring clip which retains a pair of guide rails on the gear in a channel formed in said quick release mounting mechanism.

16. An apparatus in accordance with claim 6 wherein said channel is provided with a resilient pad at its distal end for securely retaining said pair of guide rails in position without movement.

17. An apparatus in accordance with claim 1 wherein said quick release mounting mechanism is adjustably pivotally mounted on the distal end of said support bar.

18. An apparatus in accordance with claim 1 wherein said mounting bracket includes a stop to prevent said support bar from pivoting beyond a predetermined point thereby preventing said gear from contacting the wearer.
